(19) United States
(12) Patent Application Publication
(10) Pub. No.: US 2014/0101770 A1
(43) Pub. Date: Apr. 10, 2014

(54) Systems and Methods for Security Detection

(71) Applicant: Tencent Technology (Shenzhen) Company Limited, Shenzhen (CN)

(72) Inventor: Quanju Xiao, Shenzhen (CN)

(73) Assignee: Tencent Technology (Shenzhen) Company Limited, Shenzhen (CN)

(21) Appl. No.: 14/104,332

(22) Filed: Dec. 12, 2013

Related U.S. Application Data
(63) Continuation of application No. PCT/CN2013/084022, filed on Sep. 23, 2013.

(30) Foreign Application Priority Data
Sep. 24, 2012 (CN) 201210358322.4

(51) Int. Cl. G06F 21/50

(52) U.S. Cl. CPC G06F 21/50
USPC 726/25

(57) ABSTRACT

Systems and methods are provided for security detection. For example, an initiation module in a process that initiates a sensitive operation is determined; identification information of the initiation module is collected; and security of the sensitive operation is detected based on at least information associated with the collected identification information and a predetermined database.

### CROSS-REFERENCES TO RELATED APPLICATIONS

This application claims priority to Chinese Patent Application No. 201210358322.4, filed Sep. 24, 2012, incorporated by reference herein for all purposes.

### BACKGROUND OF THE INVENTION

The present invention is directed to computer technology. More particular the invention provides systems and methods for computer security. Merely by way of example, the invention has been applied to security detection. But it would be recognized that the invention has a much broader range of applicability.

With the development of science and technology, real-time protection of computers has become very important to ensure safe operations of the computers. Conventional techniques of real-time protection often monitor sensitive system operations, such as loading certain drivers, changing key items in a system registry, and injection. When a sensitive system operation is captured, information related to a process that initiates the sensitive operation is collected. For example, the information related to the process (e.g., .exe) includes at least one of the following: md5 information of the process, digital-signature information of the process, and file-vendor information of the process. Then, security of the initiating process is detected based on the information related to the process to determine whether to release the sensitive operation. For example, the security of the initiating process is detected by determining a black-or-white attribute of the initiating process based on the information related to the process. If the black-or-white attribute of the initiating process is white, the process is safe and consequently the sensitive operation can be released. If the black-or-white attribute of the initiating process is black, the initiating process is dangerous (i.e., not safe) and consequently, the sensitive operation cannot be released.

The conventional techniques of real-time protection may have some problems under certain circumstances. For example, the security detection is performed only on the process that initiates the sensitive operation. But in reality, the initiating process may include multiple modules. When the process itself is considered safe (e.g., the black-or-white attribute is white), it may include one or more modules that are dangerous (e.g., the black-or-white attribute of such modules is black). Such dangerous modules may have entered the initiating process through injection or dll hijacking and initiated the sensitive operation. The conventional techniques of real-time protection may release the sensitive operation because the initiating process itself is detected to be “safe,” even though the sensitive operation is actually initiated by the dangerous modules. The security and stability of the computer system may be severely affected. Therefore, the conventional techniques of real-time protection are often too coarse for security detection, and may lead to poor security and stability of computer systems.

Hence it is highly desirable o improve the techniques for security detection.

### BRIEF SUMMARY OF THE INVENTION

The present invention is directed to computer technology. More particularly, the invention provides systems and methods for computer security. Merely by way of example, the invention has been applied to security detection. But it would be recognized that the invention has a much broader range of applicability.

According to one embodiment, a method is provided for security detection. For example, an initiation module in a process that initiates a sensitive operation is determined; identification information of the initiation module is collected; and security of the sensitive operation is detected based on at least information associated with the collected identification information and a predetermined database.

According to another embodiment, a device for security detection includes a determination unit, a collection unit, and a detection unit. The determination unit is configured to determine an initiation module in a process that initiates a sensitive operation. The collection unit is configured to collect identification information of the initiation module. The detection unit is configured to detect security of the sensitive operation based on at least information associated with the collected information and a predetermined database.

According to yet another embodiment, a non-transitory computer readable storage medium includes programming instructions for security detection. The programming instructions are configured to cause one or more data processors to execute certain operations. For example, an initiation module in a process that initiates a sensitive operation is determined; identification information of the initiation module is collected; and security of the sensitive operation is detected based on at least information associated with the collected identification information and a predetermined database.

According to yet another embodiment, a computer-implemented system for security detection includes one or more data processors and a computer-readable storage medium. The computer-readable storage medium is encoded with instructions for commanding the data processors to execute certain operations. For example, an initiation module in a process that initiates a sensitive operation is determined; identification information of the initiation module is collected; and security of the sensitive operation is detected based on at least information associated with the collected identification information and a predetermined database.

For example, the systems and methods described herein are configured to adopt a finer detection granularity and improve security and stability of computer systems. In another example, the systems and methods described herein are configured to detect a module with a black attribute (i.e., being dangerous) that initiates a sensitive operation by hijacking a process with a white attribute (i.e., being considered as safe), so as to improve the efficiency of security detection and ensure the security and stability of computer systems.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for security detection according to one embodiment of the present invention;

FIG. 2 is a simplified diagram showing a method for security detection according to another embodiment of the present invention;

FIG. 3 is a simplified diagram showing a method for security detection according to yet another embodiment of the present invention;

FIG. 4 is a simplified diagram of a security-detection device according to one embodiment of the present invention; and

FIG. 5 is a simplified diagram showing certain components of the security-detection device as shown in FIG. 4 according to another embodiment of the present invention.

### DETAIL DESCRIPTION OF THE INVENTION

The present invention is directed to computer technology. More particularly, the invention provides systems and methods for computer security. Merely by way of example, the invention has been applied to security detection. But it would be recognized that the invention has a much broader range of applicability.

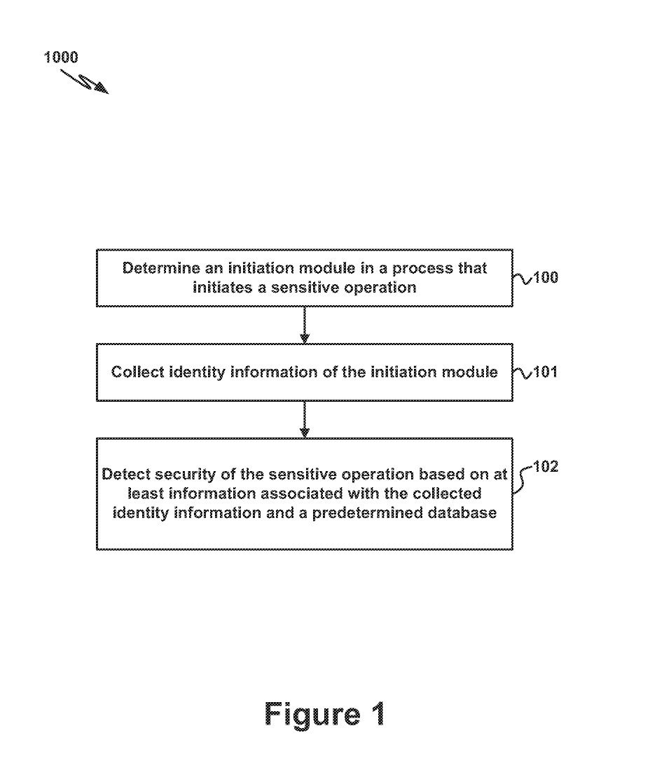

FIG. 1 is a simplified diagram showing a method for security detection according to one embodiment of the present invention. This diagram is merely an example, which should not unduly limit the scope of the claims. One of ordinary skill in the art would recognize many variations, alternatives, and modifications. The method 1000 includes at least the process 100 for determining an initiation module in a process that initiates a sensitive operation, the process 101 for collecting identification information of the initiation module, and the process 102 for detecting security of the sensitive operation based on at least information associated with the collected identification information and a predetermined database.

According to one embodiment, at the process 100, the initiation module in the process that initiates the sensitive operation is determined. For example, the sensitive operation includes loading certain drivers, changing key items in a system registry, and/or injection. In another example, at the process 101, the identification information of the initiation module is collected. As an example, the identification information of the initiation module includes at least one of the following: digital signature information, file-vendor information and file-description information. As another example, at the process 102, the security of the initiated sensitive operation is detected based on at least information associated with the collected identification information and a predetermined database. Herein, the initiation module refers to the module that initiates the sensitive operation. For example, the predetermined database includes a database of black attributes (e.g., a database that includes identification information of dangerous initiation modules) or a database of white attributes (e.g., a database that includes identification information of safe initiation modules). In another example, the predetermined database includes both the database of black attributes and the database of white attributes.

According to another embodiment, if the predetermined database includes only the database of black attributes, the security detection is performed by checking whether the collected identification information of the initiation module in the process is included in the database of black attributes. For example, if the collected identification information is included in the database of black attributes, the sensitive operation is deemed as not safe (i.e., dangerous); and if the collected identification information of the initiation module in the process is not included in the database of black attributes, the sensitive operation is considered as safe.

According to yet another embodiment, if the predetermined database includes only the database of white attributes, the security detection is performed by checking whether the collected identification information of the initiation module in the process is included in the database of white attributes. For example, if the collected identification information is included in the database of white attributes, the sensitive operation is deemed as safe; and if the collected identification information of the initiation module in the process is not included in the database of white attributes, the sensitive operation is considered as not safe (i.e., dangerous).

According to yet another embodiment, if the predetermined database includes both the database of white attributes and the database of black attributes, the security detection is performed by checking whether the collected identification information of the initiation module in the process is included in the database of white attributes or the database of black attributes. For example, if the collected identification information is included in the database of white attributes, the sensitive operation is deemed as safe, and if the collected identification information of the initiation module in the process is included in the database of black attributes, the sensitive operation is considered as not safe (i.e., dangerous). In another example, if neither the database of white attributes nor the database of black attributes includes the collected identification information, the sensitive operation is temporarily deemed to be dangerous, and prompts may be provided to the computer for users to make further determination.

In some embodiments, a security-detection device may be implemented to perform the security detection as shown in FIG. 1. For example, the security-detection device can be included in a real-time security protection equipment of a computer.

In one embodiment, after the process 102, a process for determining whether to release the sensitive operation based on at least information associated with the detection of security of the sensitive operation is executed. For example, if the initiation of the sensitive operation is determined to be safe based on at least information associated with the detection of security of the sensitive operation, the sensitive operation is released. In another example, if the initiation of the sensitive operation is determined to be dangerous based on at least information associated with the detection of security of the sensitive operation, the sensitive operation is refused to be performed, and a prompt “initiation of the sensitive operation is dangerous” may be provided to the computer, e.g., by the security-detection device. As an example, such a prompt is displayed on a computer screen to notify a user that the sensitive operation is prohibited.

In one embodiment, after the process 102, the security-detection device may provide corresponding prompts to the computer based on at least information associated with the detection of security of the sensitive operation so that a user who operates the computer may determine whether to release the sensitive operation. For example, if the initiation of the sensitive operation is determined to be safe based on at least information associated with the detection of security of the sensitive operation, a prompt “initiation of the sensitive operation is safe” is provided to the computer (e.g., on the computer screen), and the user may determine whether to release the sensitive operation using a keyboard or a mouse. In another example, if the initiation of the sensitive operation is determined to be dangerous based on at least information associated with the detection of security of the sensitive operation, a prompt “initiation of the sensitive operation is dangerous” is provided to the computer (e.g., on the computer screen), and the user may determine whether to release the sensitive operation using the keyboard or the mouse. In yet another example, the security-detection device may not automatically determine whether to release the sensitive operation after the security detection but only send a prompt to the computer to allow the user to determine whether to release the sensitive operation according to the prompt.

In another embodiment, the process 100 includes, determining the initiation module in the process that initiates the sensitive operation using a stack back-traces method, or determining the initiation module in the process that initiates the sensitive operation using an initial-thread-address-inquiry method.

In yet another embodiment, before the process 102, a process for collecting the parameters associated with the sensitive operation is executed, For example, the parameters of the sensitive operation include certain basic parameters of the sensitive operation. In another example, if the sensitive operation involves loading certain drivers, the parameters of the sensitive operation include the driver names and/or related directories. In yet another example, if the sensitive operation involves changing a key item of the system registry, the parameters include a registry key, a registry item and altered new value(s) and old value(s). In yet another example, if the sensitive operation is injection, the parameters include the name and/or the process ID of an injection process. In certain embodiments, the above-noted process for collecting parameters associated with the sensitive operation, and the processes 100 and 101 have no sequential relationship.

According to one embodiment, before the process 100, a process for monitoring and capturing the sensitive operation is executed. For example, the above-noted process for collecting the parameters of the sensitive operation is executed after the process for monitoring and capturing the sensitive operation. In another example, the process 102 includes a process for detecting the security of the sensitive operation based on at least information associated with the identification information of the initiation module, the parameters of the sensitive operation and the predetermined database. In yet another example, the process for detecting the security of the sensitive operation based on at least information associated with the identification information of the initiation module, the parameters of the sensitive operation and the predetermined database includes the following steps:

(1) detecting a black-or-white attribute of the initiation module based on at least information associated with the identification information of the initiation module and the predetermined database;
(2) detecting a black-or-white attribute of the sensitive operation based on at least information associated with the parameters of the sensitive operation and the predetermined database; and
(3) detecting the security of the sensitive operation based on at least information associated with the black-or-white attribute of the initiation module and the black-or-white attribute of the sensitive operation.

In one embodiment, the predetermined database includes a database of black attributes (i.e., a database that includes identification information of dangerous initiation modules) or a database of white attributes (i.e., a database that includes identification information of safe initiation modules). In another embodiment, the predetermined database includes both the database of black attributes and the database of white attributes.

According to another embodiment, if the predetermined database includes only the database of black attributes, the step (1) is performed by checking whether the collected identification information of the initiation module in the process is included in the database of black attributes. For example, if the collected identification information is included in the database of black attributes, the sensitive operation is deemed as not safe, i.e., the black-or-white attribute of the initiation module is black. In another example, if the collected identification information of the initiation module in the process is not included in the database of black attributes, the black-or-white attribute of the initiation module is white, i.e., the sensitive operation is safe.

According to yet another embodiment, if the predetermined database includes only the database of white attributes, the step (1) is performed by checking whether the collected identification information of the initiation module in the process is included in the database of white attributes. For example, if the collected identification information is included in the database of white attributes, the sensitive operation is deemed as safe, i.e., the black-or-white attribute of the initiation module is white. In another example, if the collected identification information of the initiation module in the process is not included in the database of white attributes, the black-or-white attribute of the initiation module is black, i.e., the sensitive operation is dangerous.

According to yet another embodiment, if the predetermined database includes both the database of white attributes and the database of black attributes, the step (1) is performed by checking whether the collected identification information of the initiation module in the process is included in the database of white attributes or the database of black attributes. For example, if the collected identification information of the initiation module in the process is included in the database of black attributes, the sensitive operation is considered as not safe, i.e., the black-or-white attribute of the initiation module is black. In another example, if the collected identification information is included in the database of white attributes, the sensitive operation is deemed as safe, i.e., the black-or-white attribute of the initiation module is white. In yet another example, if neither the database of white attributes nor the database of black attributes includes the collected identification information, the sensitive operation is temporarily deemed to be not safe, i.e., the black-or-white attribute of the initiation module is black. In yet another example, prompts arc provided to the computer to inform a user that the identification information of the initiation module is not detected in the predetermined database and the initiation module is temporarily considered as not safe.

Similar to what is described above for the step (1), the step (2) may be performed by checking whether certain parameters of the sensitive operation are included in the predetermined database, in certain embodiments. For example, the step (3) includes: determining the sensitive operation is safe if both the black-or-white attribute of the initiation module and the black-or-white attribute of the sensitive operation are white; and determining the sensitive operation is dangerous if the black-or-white attribute of the initiation module and/or the black-or-white attribute of the sensitive operation are black.

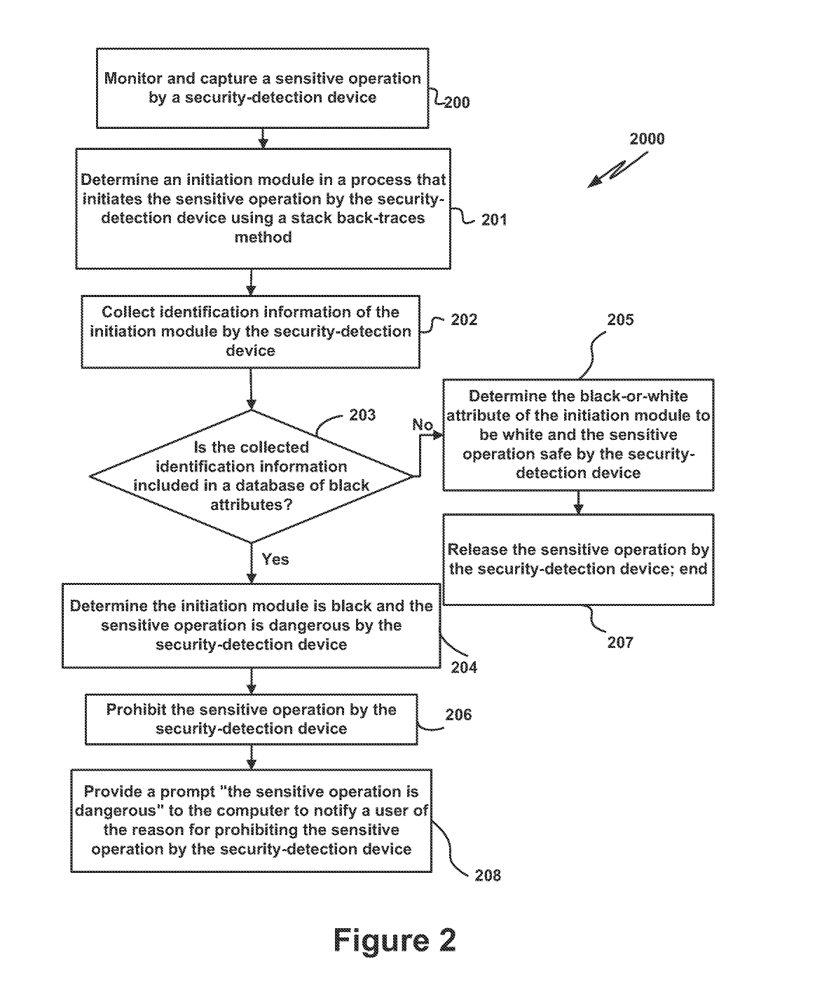

FIG. 2 is a simplified diagram showing a method for security detection according to another embodiment of the present invention. This diagram is merely an example, which should not unduly limit the scope of the claims. One of ordinary skill in the art would recognize many variations, alternatives, and modifications. The method 2000 includes multiple processes that are performed, e.g., by a security-detection device.

According to one embodiment, the method 200 includes the process 200 for monitoring and capturing a sensitive operation, the process 201 for determining an initiation module in a process that initiates the sensitive operation using a stack back-traces method, the process 202 for collecting identification information of the initiation module, and the process 203 for determining whether the collected identification information is included in a predetermined database of black attributes. For example, if the collected identification information is included in the predetermined database of black attributes, the process 204 is executed; otherwise the process 205 is executed.

According to another embodiment, the process 204 includes determining that a black-or-white attribute of the initiation module is black and determining that the sensitive operation is dangerous. For example, at the process 205, the black-or-white attribute of the initiation module is determined to be white and the sensitive operation is determined to be safe. In another example, the process 207 is executed, where the sensitive operation is released to be performed. In yet another example, at the process 206, the sensitive operation is prohibited. In yet another example, the process 208 is executed, where a prompt “the sensitive operation is dangerous” is provided to the computer to notify a user of the reason for prohibiting the sensitive operation.

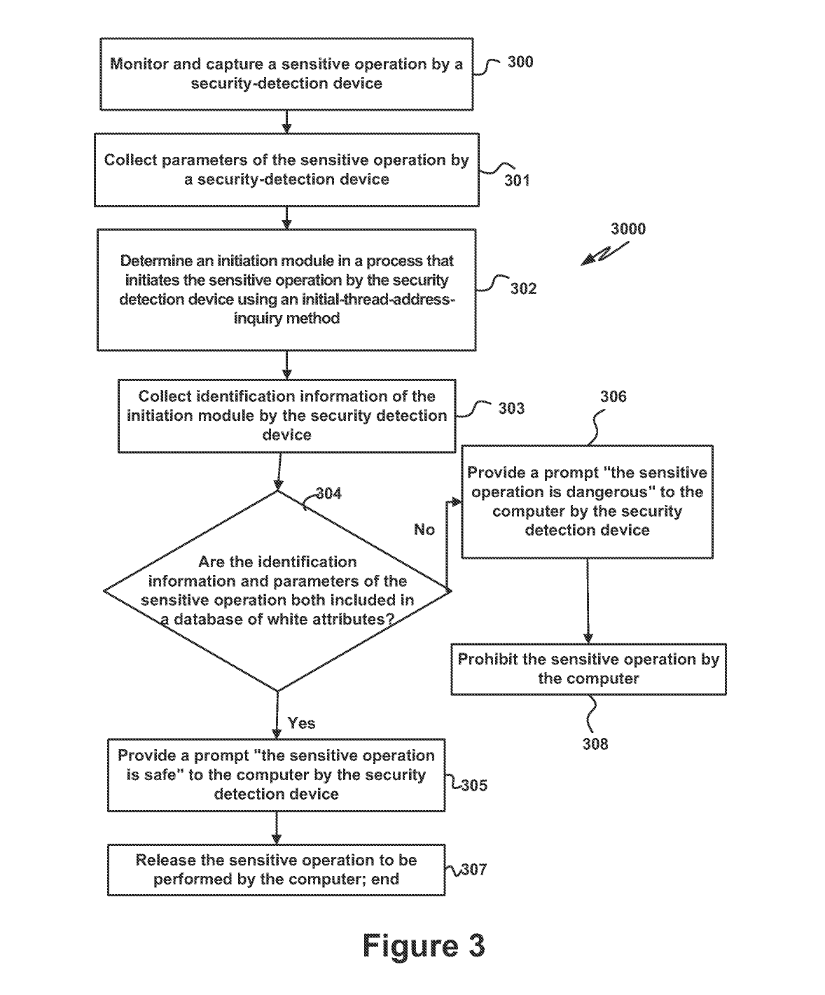

FIG. 3 is a simplified diagram showing a method for security detection according to yet another embodiment of the present invention. This diagram is merely an example, which should not unduly limit the scope of the claims. One of ordinary skill in the art would recognize many variations, alternatives, and modifications. The method 3000 includes at least the process 300 for monitoring and capturing a sensitive operation by a security-detection device, the process 301 for collecting parameters of the sensitive operation by the security-detection device, the process 302 for determining an initiation module in a process that initiates the sensitive operation by the security-detection device using an initial-thread-address-inquiry method, and the process 303 for collecting identification information of the initiation module by the security-detection device. The method 3000 further includes the process 304 for determining whether the collected identification information and parameters of the sensitive operation are both included in a predetermined database of white attributes.

According to one embodiment, if the collected identification information and the parameters of the sensitive operation are both included in the predetermined database of white attributes, the process 305 is executed, where a prompt “the sensitive operation is safe” is provided to the computer by the security-detection device. For example, the computer releases the sensitive operation to be performed.

According to another embodiment, if the collected identification information and the parameters of the sensitive operation are not both included in the predetermined database of white attributes, the process 306 is executed, where a prompt “the sensitive operation is dangerous” is provided to the computer by the security-detection device. For example, the computer prohibits the sensitive operation.

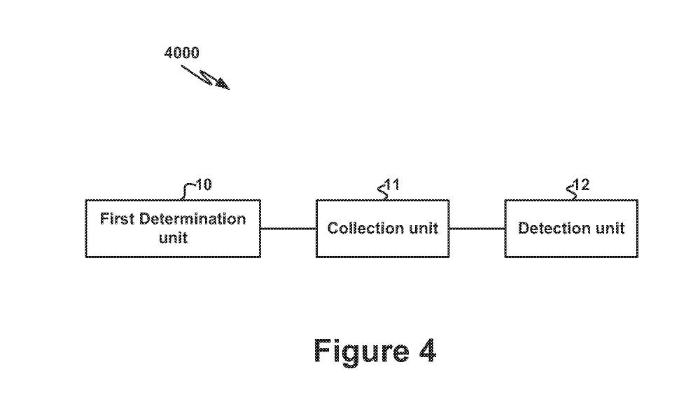

FIG. 4 is a simplified diagram of a security-detection device according to one embodiment of the present invention. This diagram is merely an example, which should not unduly limit the scope of the claims. One of ordinary skill in the art would recognize many variations, alternatives, and modifications. The security-detection device 4000 includes a first determination unit 10, a collection unit 11 and a detection unit 12.

According to one embodiment, the first determination unit 10 is configured to determine an initiation module in a process that initiates a sensitive operation. For example, the collection unit 11 is connected with the first determination unit 10 and is configured to collect identification information of the initiation module determined by the first determination unit 10. In another example, the detection unit 12 is connected with the collection unit 11 and is configured to detect security of the sensitive operation based on at least information associated with the information collected by the collection unit 11 and a predetermined database. The security-detection device 4000, as shown in FIG. 4, performs security detection by implementing one or more of the methods described above, such as the methods 1000, 2000 and/or 3000, in certain embodiments.

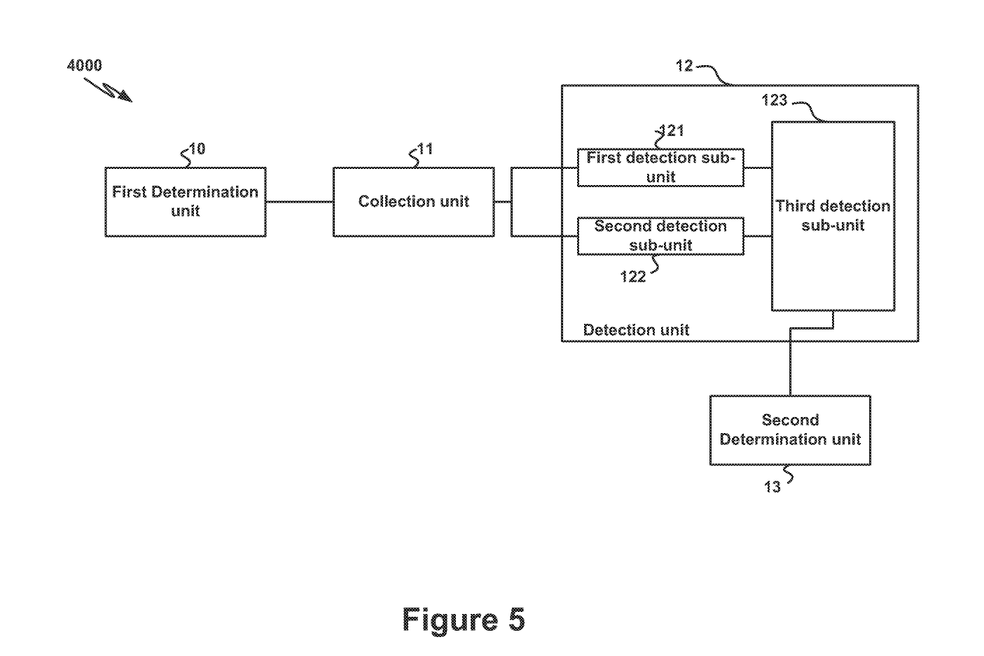

FIG. 5 is a simplified diagram showing certain components of the security-detection device as shown in FIG. 4 according to another embodiment of the present invention. This diagram is merely an example, which should not unduly limit the scope of the claims. One of ordinary skill in the art would recognize many variations, alternatives, and modifications. In addition to the first determination unit 10, the collection unit 11 and the detection unit 12, the security-detection device 4000 further includes a second determination unit 13. The detection unit 12 includes a first detection sub-unit 121, a second detection sub-unit 122, and a third detection sub-unit 123.

According to one embodiment, the second determination unit 13 is configured to determine whether to release the sensitive operation based on at least information associated with the detection of security of the sensitive operation performed by the detection unit 12. For example, the first determination unit 10 is further configured to determine the initiation module in the process that initiates the sensitive operation using a stack back-traces method, or determine the initiation module in the process that initiates the sensitive operation using an initial-thread-address-inquiry method. In another example, the collection unit 11 is further configured to collect parameters associated with the sensitive operation before the detection unit 12 performs the detection of security of the sensitive operation. In yet another example, the detection unit 12 is further configured to detect the security of the sensitive operation based on at least information associated with identification information of the initiation module, the parameters associated with the sensitive operation and the predetermined database.

According to another embodiment, the first detection sub-unit 121 is specifically connected with the collection unit 11 and configured to detect a first black-or-white attribute of the initiation module based on at least information associated with the identification information of the initiation module and the predetermined database. For example, the second detection sub-unit 122 can also be specifically connected with the collection unit 11 and configured to detect a second black-or-white attribute of the sensitive operation based on at least information associated with the parameters of the sensitive operation and the predetermined database. In another example, the third detection sub-unit 123 is connected with the first detection sub-unit 121 and the second detection sub-unit 122, and configured to detect the security of the sensitive operation based on at least information associated with the first black-or-white attribute of the initiation module detected by the first detection sub-unit 121 and the second black-or-white attribute of the sensitive operation detected by the second detection sub-unit 122.

According to yet another embodiment, the third detection sub-unit is further configured to, in response to both the first black-or-white attribute and the second black-or-white attribute being white, determine the sensitive operation to be safe, and in response to the first black-or-white attribute and/or the second black-or-white attribute being black, determine the sensitive operation to be dangerous. For example, the second determination unit 13 is connected with the third detection sub-unit 123 and configured to determine Whether to release the sensitive operation based on at least information associated with the detection of security of the sensitive operation performed by the third detection sub-unit 123. As an example, the identification information of the initiation module includes one selected from a group consisting of: digital-signature information, file-vendor information, and file-description information.

The security-detection device 4000, as shown in FIG. 5, performs security detection by implementing one or more of the methods described above, such as the methods 1000, 2000 and/or 3000, in some embodiments. In certain embodiments, the security-detection device 4000, as shown in FIG. 4 or FIG. 5, is implemented on a real-time protection server for security detection of a client computer, using certain software or hardware.

According to one embodiment, a method is provided for security detection. For example, an initiation module in a process that initiates a sensitive operation is determined; identification information of the initiation module is collected; and security of the sensitive operation is detected based on at least information associated with the collected identification information and a predetermined database. For example, the method is implemented according to at least FIG. 1, FIG. 2, and/or FIG. 3.

According to another embodiment, a device for security detection includes a determination unit, a collection unit, and a detection unit. The determination unit is configured to determine an initiation module in a process that initiates a sensitive operation. The collection unit is configured to collect identification information of the initiation module. The detection unit is configured to detect security of the sensitive operation based on at least information associated with the collected information and a predetermined database. For example, the device is implemented according to at least FIG. 4, and/or FIG. 5.

According to yet another embodiment, non-transitory computer readable storage medium includes programming instructions for security detection. The programming instructions are configured to cause one or more data processors to execute certain operations. For example, an initiation module in a process that initiates a sensitive operation is determined; identification information of the initiation module is collected; and security of the sensitive operation is detected based on at least information associated with the collected identification information and a predetermined database. For example, the storage medium is implemented according to at least FIG. 1, FIG. 2, and/or FIG. 3.

According to yet another embodiment, a computer-implemented system for security detection includes one or more data processors and a computer-readable storage medium. The computer-readable storage medium is encoded with instructions for commanding the data processors to execute certain operations. For example, an initiation module in a process that initiates a sensitive operation is determined; identification information of the initiation module is collected; and security of the sensitive operation is detected based on at least information associated with the collected identification information and a predetermined database. For example, the system is implemented according to at least FIG. 1, FIG. 2, and/or FIG. 3.

The above only describes several scenarios presented by this invention, and the description is relatively specific and detailed, yet it cannot therefore be understood as limiting the scope of this invention's patent. It should be noted that ordinary technicians in the field may also without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A processor-implemented method for security detection, comprising:
determining, using one or more data processors, an initiation module in a process that initiates a sensitive operation;
collecting, using the one or more data processors, identification information of the initiation module; and
detecting, using the one or more data processors, security of the sensitive operation based on at least information associated with the collected identification information and a predetermined database.

2. The method of claim 1, further comprising:
determining whether to release the sensitive operation based on at least information associated with the detection of security of the sensitive operation.

3. The method of claim 1, wherein the determining an initiation module in a process that initiates a sensitive operation includes:
determining the initiation module in the process that initiates the sensitive operation using a stack back-traces method; or
determining the initiation module in the process that initiates the sensitive operation using an initial-thread-address-inquiry method.

4. The method of claim 1, further comprising:
collecting parameters associated with the sensitive operation.

5. The method of claim 4, wherein the detecting security of the sensitive operation based on at least information associated with the collected identification information and a predetermined database includes:
detecting the security of the sensitive operation based on at least information associated with identification information of the initiation module, the parameters associated with the sensitive operation and the predetermined database.

6. The method of claim 4, wherein the detecting security of the sensitive operation based on at least information associated with the collected identification information and a predetermined database includes:
detecting a first black-or-white attribute of the initiation module based on at least information associated with the identification information of the initiation module and the predetermined database;
detecting a second black-or-white attribute of the sensitive operation based on at least information associated with the parameters of the sensitive operation and the predetermined database; and
detecting the security of the sensitive operation based on at least information associated with the first black-or-white attribute of the initiation module and the second black-or-white attribute of the sensitive operation.

7. The method of claim 6, wherein the detecting the security of the sensitive operation based on at least information associated with the first black-or-white attribute of the initiation module and the second black-or-white attribute of the sensitive operation includes:
in response to both the first black-or-white attribute and the second black-or-white attribute being white, determining the sensitive operation to be safe; and
in response to the first black-or-white attribute or the second black-or-white attribute being black, determining the sensitive operation to be dangerous.

8. The method of claim 7, wherein the sensitive operation is determined to be dangerous in response to both the first black-or-white attribute and the second black-or-white attribute being black.

9. The method as in one of claims 1, wherein the identification information of the initiation module includes one selected from a group consisting of: digital-signature information, file-vendor information, and file-description information.

10. A device for security detection, comprising:
a first determination unit configured to determine an initiation module in a process that initiates a sensitive operation;
a collection unit configured to collect identification information of the initiation module; and
a detection unit configured to detect security of the sensitive operation based on at least information associated with the collected information and a predetermined database.

11. The device of claim 10, further comprising:
a second determination unit configured to determine whether to release the sensitive operation based on at least information associated with the detection of security of the sensitive operation.

12. The device of claim 10, wherein the first determination unit is further configured to determine the initiation module in the process that initiates the sensitive operation using a stack backtraces method, or determine the initiation module in the process that initiates the sensitive operation using an initial-thread-address-inquiry method.

13. The device of claim 10, wherein the collection unit is further configured to collect parameters associated with the sensitive operation.

14. The device of claim 13, wherein the detection unit is further configured to detect the security of the sensitive operation based on at least information associated with identification information of the initiation module, the parameters associated with the sensitive operation and the predetermined database.

15. The device of claim 13, wherein the detection unit includes:
a first detection sub-unit configured to detect a first black-or-white attribute of the initiation module based on at least information associated with the identification information of the initiation module and the predetermined database;
a second detection sub-unit configured to detect a second black-or-white attribute of the sensitive operation based on at least information associated with the parameters of the sensitive operation and the predetermined database; and
a third detection sub-unit configured to detect the security of the sensitive operation based on at least information associated with the first black-or-white attribute of the initiation module and the second black-or-white attribute of the sensitive operation.

16. The device of claim 15, wherein the third detection sub-unit is further configured to, in response to both the first black-or-white attribute and the second black-or-white attribute being white, determine the sensitive operation to be safe, and in response to the first black-or-white attribute or the second black-or-white attribute being black, determine the sensitive operation to be dangerous.

17. The device of claim 16, wherein the third detection sub-unit is further configured to, in response to both the first black-or-white attribute and the second black-or-white attribute being black, determine the sensitive operation to be dangerous.

18. The device as in one of claims 10, wherein the identification information of the initiation module includes one selected from a group consisting of: digital-signature information, file-vendor information, and file-description information.

19. A non-transitory computer readable storage medium comprising programming instructions for security detection, the programming instructions configured to cause one or more data processors to execute operations comprising:
determining an initiation module in a process that initiates a sensitive operation;
collecting identification information of the initiation module; and
detecting security of the sensitive operation based on at least information associated with the collected identification information and a predetermined database.

20. A computer-implemented system for security detection, said system comprising:
one or more data processors; and
a computer-readable storage medium encoded with instructions for commanding the data processors to execute operations including:
determining an initiation module in a process that initiates a sensitive operation;
collecting identification information of the initiation module; and
detecting security of the sensitive operation based on at least information associated with the collected identification information and a predetermined database.
